(19) United States
(12) Patent Application Publication
(10) Pub. No.: US 2002/0068544 A1
(43) Pub. Date: Jun. 6, 2002

(54) Method and system for remotely controlling a plurality of electrical switches

(76) Inventors: Ziv Barzilay, Ramat-Hasharon (IL); Zvi Zweig, Ramat Hasharon (IL)

Correspondence Address: Mitchell S. Feller, Esq., Clifford Chance Rogers & Wells LLP, 200 Park Avenue, New York, NY, 10016, US

(21) Appl. No.: 09/727,911

(22) Filed: Dec. 1, 2000

(51) Int. Cl. H04M 11/00

(52) U.S. Cl. 455/406; 455/420; 455/414

(57) ABSTRACT

A method and system for signaling wireless switching devices on behalf of a plurality of users via a cellular network includes a switch control system which is coupled to the cellular network mobile switching center. Users register switches with the system by providing the switch ID and the geographic location where the switch is installed. The system registers the switch as a wireless device present in a cell that serves the specified location. The user can then define a switching schedule for the registered the switches. Upon the occurrence of a scheduled switching event, a switching message is generated for the appropriate switch and is routed, via the cellular network, to the appropriate transmitter for subsequent broadcast.

### FIELD OF THE INVENTION

This invention is related to a method and system for remotely controlling electrical switches. More particularly, the present invention is directed to an improved method and system for remotely switching a plurality of appliances schedules specified by multiple users, and an in-line switching module for use in such a system.

### BACKGROUND

It is useful for individuals to be able to control from a remote location various electrical and electronic devices, such as lights and appliances in their home. One conventional system for controlling home appliances uses a computer control system located in the home and special switching units connected to each appliance to be controlled. The computer control system sends signals to the switch units over the local power supply wiring system. These signals are received by the switches connected to the same wiring system and are used to selectively turn the appliance on and off. Many variations of a local switch control system utilizing power line communication techniques are known. In some variations, the controlling computer can be programmed remotely, such as through a dial up telephone connected to the system. A system of this type is disclosed, for example, in U.S. Pat. No. 4,442,319 entitled “Telephone Accessible Appliance Control System”.

Although these types of system can be effective within a geographically limited environment, such as a user's home, the controlling system cannot access switches which are connected to different power line circuits. In addition, each user of the system is required to obtain their own controlling computer system and maintain its programming and operability. This can greatly increase the cost and complexity of the system and place it out of reach of many who would otherwise benefit from remote appliance switching.

Some efforts have been made to provide a wireless system for controlling remote devices. For example, U.S. Pat. No. 5,588,308, entitled “System and Method for Signaling a Device at a Remote Location over a Wireless Network”, discloses a system in which a paging unit is integrated within a device to be controlled. To send control signals to the device, the user accesses the paging network and dials the pager number of the pager unit in the device to be controlled. When the page is received, the pager processes the received message and acts accordingly. A similar system is the OnStar® control system provided by General Motors, which provides remote operator access and control of various automotive functions, such as door locks, through a dedicated cellular network which communicates with a cellular transceiver integrated within the automobile. While these existing systems are suitable for their particular operating environments, they are limited in their scope of operation and do not permit multiple users to remotely schedule control of various appliances. In addition, it can be difficult for a user to add a previously unsupported appliance to the control system.

Accordingly, there is a need to provide an improved method and system for providing remote switching control over arbitrary appliances, which method and system is more flexible and simpler to implement than conventional systems.

There is a further need to provide such a in a manner to permit implementation via existing communication networks without any major or expensive changes in the equipment or the operational networks.

### SUMMARY OF THE INVENTION

These and other needs are met by a method and system of the present invention wherein a centralized switch control system is provided and connected to a wireless network, such as a cellular telephone network. The system is configured to permit users to remotely control one or more switching control units, which units receive and process wireless signals and act on them if appropriate to alter the state of a connected appliance, e.g., by turning it on or off.

Users access the switch control system through a computer or telephonic interface and register one or more switching devices by specifying the assigned switch ID and preferably the location where the switching device is installed. A database is provided for maintaining the switch registration information as well as appropriate user profile data.

Once switches have been registered, the user can define a switching schedule for each of their switching units, which schedule specifies the time for various switching events. Upon the occurrence of a switching event, the system generates a message directed to the particular switching unit at issue and forwards the message to an appropriate transmitter serving the location defined for the switching unit.

In a preferred cellular-network based implementation, when switch units are registered with the switch control system, the specified switch location is processed to identify a cell or other region in the wireless network which services that location. The switch unit is then “registered” in the cellular network as being a wireless device which is present in the identified cell. This procedure permits the existing data routing functionality of the cellular network to be leveraged and used pass messages to particular switching units without requiring the switching units to initially connect to the wireless network so that the network can determine where the device is located. Alternatively, for switching units which contain cellular transmit capabilities, the unit can connect to the cellular network when first installed. This transmission can be used by the network to determine the cell in which the switch unit is located and register the switch as being present there.

The switching units themselves can be implemented in a variety of ways. In one embodiment, the switching units are discrete devices which can be connected between an appliance and its power supply. In another embodiment, the unit can be integrated within an appliance itself and used to provide soft-switching capabilities, such as placing the appliance in standby mode, or controlling other appliance functions. In yet a further embodiment, the switching unit can act as a “translator” between the cellular switching signals and a local or personal wireless network protocol, such as BlueTooth, to eliminate the need to directly connect the switching unit to the controlled appliance(s).

Advantageously, the system permits switch units for multiple users to be controlled from a central location and allows users to easily control switching units which may be located at varying geographic locations. Further, the present system provides and additional service which can be offered by cellular networks to increase network utilization and revenue opportunities. Other advantageous will be provided, as will be recognized by those of skill in the art.

### BRIEF DESCRIPTION OF THE FIGURES

The foregoing and other features of the present invention will be more readily apparent from the following detailed description and drawings of illustrative embodiments of the invention in which:

FIG. 1 is a block diagram showing the high level architecture of one embodiment of a switch control system according to the invention;

FIG. 2 is a block diagram showing the major systems and data tables of the control system of FIG. 1;

FIG. 3 is a block diagram of a preferred appliance control module;

FIG. 4 is a flowchart of the high-level functionality of the switch control network; and

FIG. 5 flow chart illustrating a method of billing users for use of system of the invention.

### DETAILED DESCRIPTION OF THE PREFERRED EMBODIMENTS

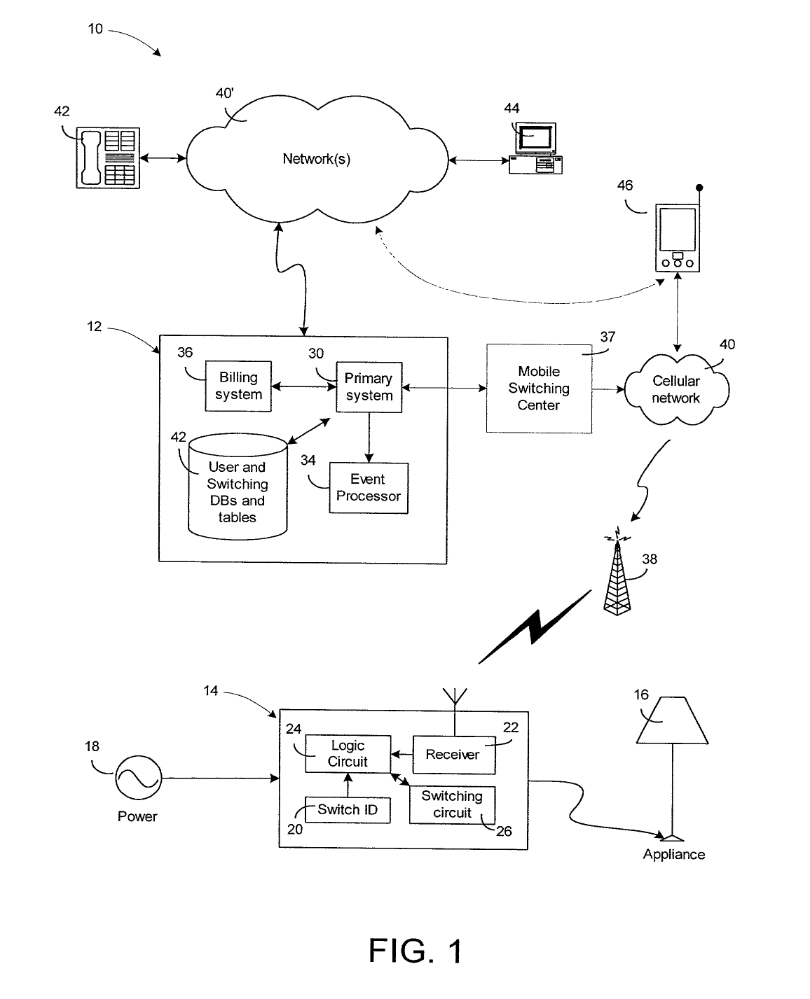

Turning to FIG. 1, there is shown a high level diagram of a system 10 including a central switch control system 12 which is configured to send switching control signals to a plurality of remotely located device switching units 14. A switching unit 14 can be integrated within an appliance 16 or separately placed between the appliance 16 and its power supply 18. Each switch 14 can be assigned a unique switch ID 20 and includes a suitable RF receiver 22 coupled to a logic and control circuit 24 which drives a power switching circuit 26 or other appliance control circuitry. The logic circuit is configured to toggle the switching circuit, and thus control power to the appliance 16, in response to messages received via receiver 22, when the received messages contain the appropriate switch ID. The switch 14 can be integrated with the controlled appliance 16 such that, rather than completely disconnecting the power to the appliance, it performs a “soft switching” function instead to, for example, place the appliance in a stand-by mode.

The central system 12 is driven by a primary control system 30 which has access to data concerning the various users, registered switches, and switch schedules. An event processor 34 can respond to scheduled switching events and initiate the broadcast of control messages to the appropriate switches via a wireless transmitter. A billing system 36 can also be included in the control system and used for processing usage and service fees for individual users. Preferably, communication with the various switching units 14 is via an established wireless network 40, such as a cellular network with base station transmitter 38, and the system 12 is connected to or integrated within the mobile switching control system 37. In a system where the central system 12 is coupled to the mobile switching center 37, various functionality can be distributed throughout the wireless network control systems and charges for remote switching activities can be assessed to users by means of a combined bill which includes, e.g., wireless telephone charges.

The central system 12 can be accessed by users through the wireless network 40 or one or more other communication networks 40′. For example, users can access the system 12 through a conventional telephone 42, a computer system 44, or another computer or hand held device, such as a cell phone or wireless PDA 46. As discussed in more detail below, the user can register new switches, review and update the switching schedule for their registered switches, etc. by accessing the central system 12. Advantageously, the central system 12 provides functionality similar to a conventional in-home powerline switch control system but frees the user from having to purchase and maintain their own control unit. Depending on how the switch 14 is integrated with the appliance, additional control functionality can also be provided. In addition, because the switching messages are transmitted using a wireless network, a single user can easily register and control switches which are located in a variety of geographic regions.

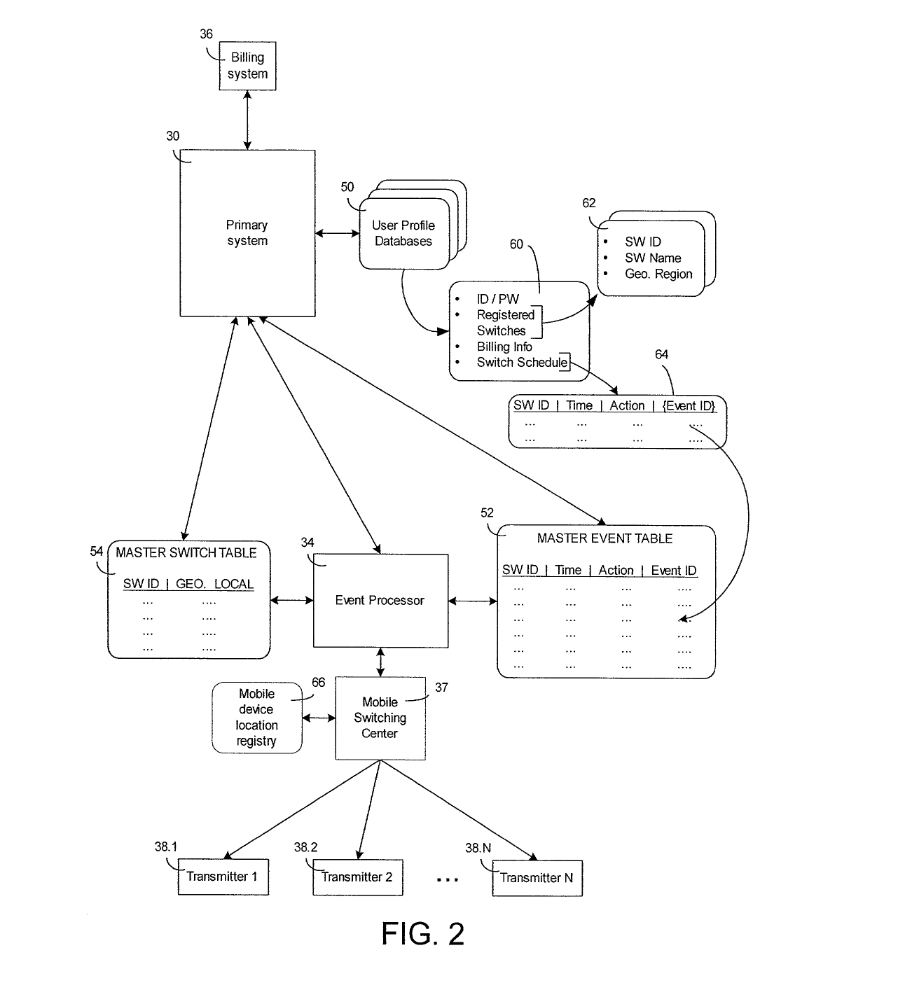

Turning to FIG. 2, there is shown a block diagram of one implementation of the control system 12 and various data files. The primary system 30 maintains a plurality of user profiles 60 stored in a user profile database 50. Each user profile specifies the particular switches which are registered to that user and can also include a switch schedule defined by the user. The user profile can further include access information, such as a user ID and password, as well as billing information, such as rate codes and how charges are to be billed to the user.

Switch registration information can be specified in one or more registration objects 62 stored in or linked to the user profile and which specify the ID assigned to a given switch. In addition, a switch registration object 62 can further include a switch name assigned to the switch by the user for reference, as well as the geographic region or wireless cell within which the registered switch is located for use in routing control messages to an appropriate transmitter for broadcast.

Switching schedule information can be organized in various ways. For example, a schedule table 64 can be provided which specifies, for each scheduled event, the switch ID, the time the action should occur, and the action itself. An action would generally specify that the switch should be turned on or off at a particular time, but other actions may also be possible depending on the sophistication of the switches 14 and how they are integrated in the respective appliances 16. In one embodiment, the schedule table 64 is a subset of a master event table 52 used by the event processor 34. In such an arrangement, an event ID field can also be provided to link a scheduled event specified in the schedule table 64 to the corresponding event in the master event table 52.

The event processor 34 responds to the occurrence of the various events defined in the event table 52. Various techniques for maintaining and processing a table of scheduled events will be known to those of skill in the art and the particular technique used in the present invention can be selected according to various design considerations, such as the software platform and development tools in use, as well as the ease of interoperability with the primary control system, etc. When a scheduled event should be processed, the event processor constructs an appropriate control message for the designated switch and forwards it to the wireless network for transmission. Preferably, the transmission network is configured such that a message can be directed to a transmitter in a specific geographical region for transmission.

When such a system is used, the event processor 34, in formulating the control message, can access a master switch table 54 to determine the geographic location of the switch to which the message is directed. Alternatively, the geographic location (or even a preformatted control message) can be included in the event table. The geographic information can then used by the transmission network to route the message to the appropriate transmitter, such as one or more of transmitter 38.1 through 38.N. Various techniques known to those of skill in the art are available for performing appropriate routing functions to direct a message to a particular transmitter in a network.

In an alternative embodiment particularly well suited for use in a cellular-telephone based system, the location information provided when a switch is registered is processed to determine a particular cellular network cell or base station which covers the switch's location. The switch ID can then be registered in the cellular network's mobile device location registry 66 as being present in the identified cell or base station or having that cell or station as its home location. As a result, the message routing functionality already present in the cellular system can be leveraged to route transmissions to a designated switch 14 to the correct base station transmitter 38 for transmission.

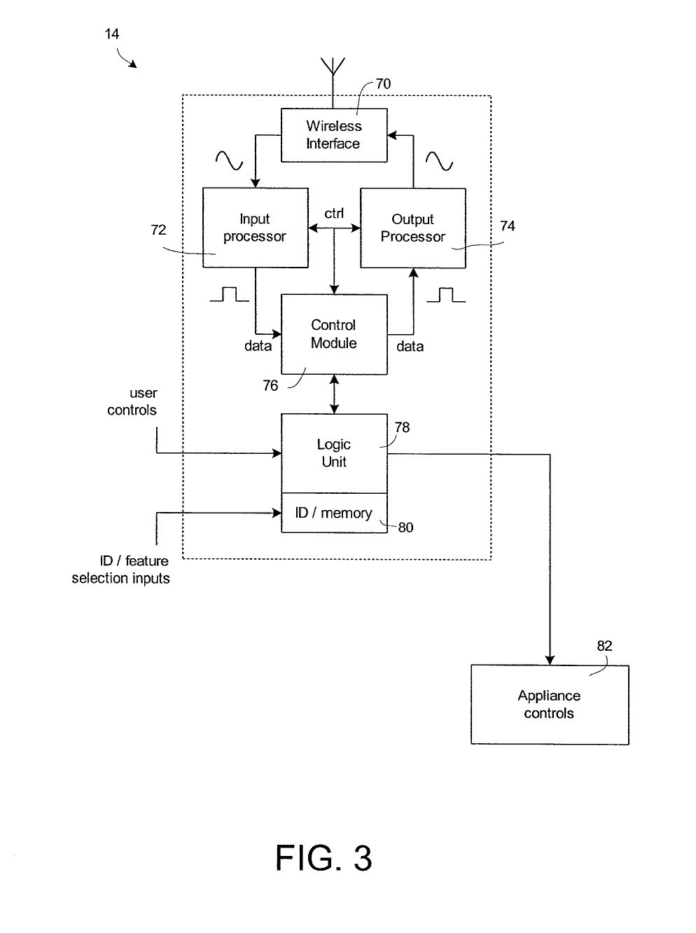

Turning to FIG. 3, there is shown a detailed block diagram of a preferred implementation of the switching unit 14 which can be plugged into or otherwise in communication with an appliance. Briefly, the switch is configured to receive messages transmitted over the wireless network 38. When a message is received, the message header is examined to determine whether it contains the ID assigned to that switch. If the message is directed to that switch, the actions specified in the message is extracted and the appropriate switching actions are taken.

In a preferred embodiment, the switch 14 is configured to receive, and possibly transmit, data via a conventional cellular network. Most preferably, most or all of the functionality is packaged in a single integrated chip or multi-chip module which can be easily and inexpensively produced and integrated with the circuitry of an existing appliance. Alternatively, the switch 14 can be packaged as a stand-alone device to which is connected to the appliance, e.g., by being plugged into an appropriate port or slot in the appliance, or placed directly in-line between the appliance and the power supply.

In the preferred embodiment of FIG. 3, signals are received via a wireless interface unit 70. Analog input signals are processed by an input processor 72 to demodulate and extract data signals which are embedded in the communication and pass the signals to a control module 76. Transmit capabilities can also be provided, although not required. If so, an output processor 74 is provided to convert data output signals from the control module 76 into a modulated data signal appropriate for the communication media, which output signal is then passed to the wireless interface 70.

The interface 70 and input and output processors 72, 74 should be configured to operate in frequency bands appropriate to the method of wireless communication employed and preferably are robust enough to operate under within various cellular protocols and frequency bands where, for a typical cellular signaling, the I/O frequency bands can range anywhere from 10 Mhz to over 2 Ghz and from 0.2 Mhz to 2.0 Mhz. Control signals generated by the control module 76 can be used to adjust the input and output transmission parameters as needed. Specific appropriate receiver or transceiver circuitry to receive and possibly transmit signals to a cellular network is known to those of skill in the art.

A major function of the control module 76 is to process received data signals and manage any handshaking protocols required to communicate with the base station. When a signal is received, the control module 76 extracts the device ID embedded in the initial alert signal sent from the base station transmitter and passes it to the logic unit 78 which checks to determine if the ID matches the ID provided in the memory 80. The logic unit 78 can be of varying complexity, depending on the desired sophistication of the device and the types of appliance controls available. In a very simple implementation, the unit comprises an XOR unit which compares the stored device ID with the received ID and indicates whether there is a match and this matching signal is used to toggle a power relay or issue a soft-switching or standby signal. Other functionality can also be provided as required to toggle appliance power or other appliance functions. In addition, flash memory or other programmable memory 80 can be used to allow the operation and/or ID of the switching unit 14 to be easily modified. Further, various user controls can also be provided. In particular, the user can be permitted to define a supplemental device ID for use where appropriate, to enable or disable various functions, and to configure the switching unit 14 for the proper wireless protocol.

Although the connection between the switching unit has been shown as hard-wired, in an alternative embodiment, the switching unit can communicate with the appliance through its own wireless interface. In such a situation, the switching unit can be considered a translation device which will receive wireless (cellular) switching commands and convert them to the appropriate local wireless protocol. Various wireless protocols can be used, including the BlueTooth personal area wireless connectivity protocol.

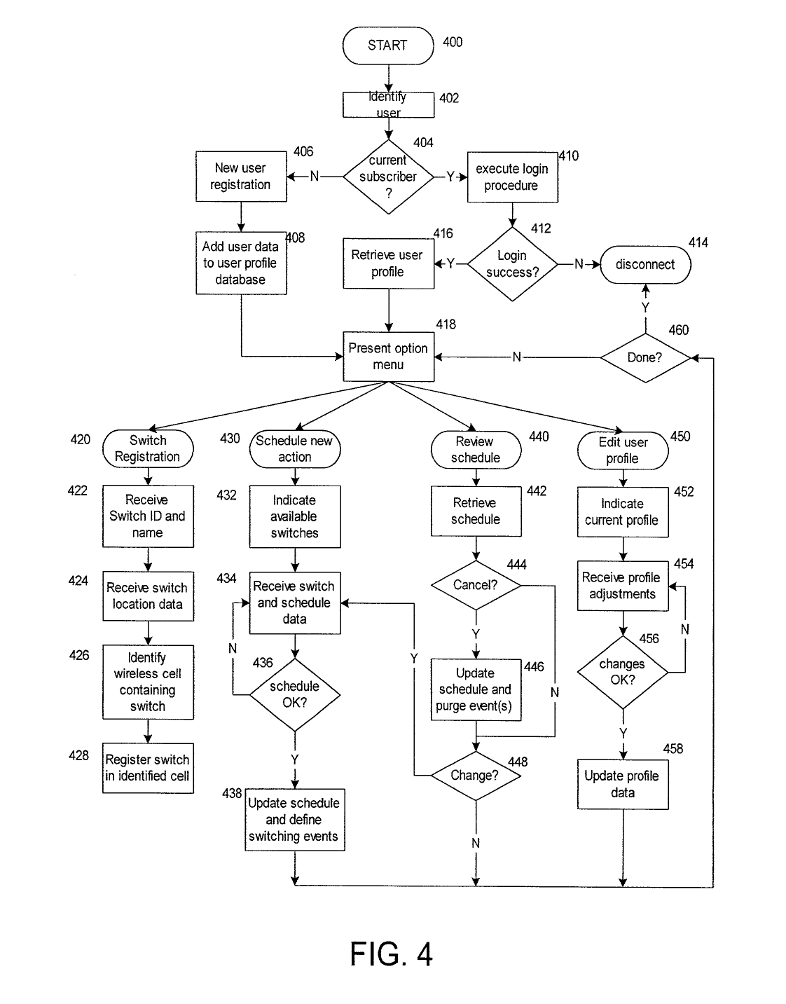

Turning to FIG. 4, there is shown a high level flow chart of the operation of the switching control system 30. When a user accesses the system (step 400), the user is first identified (step 402). The user can be identified through a designated PIN number entered on a telephone keypad, via a caller ID telephone number, or through the use of various other techniques. A determination can then be made regarding whether the user is a current subscriber (step 404). If the caller is a new user, an appropriate registration procedure can be executed (step 406) and the new user data added to the user profile database (step 408). For existing users, a logon procedure, such as requiring entry of an access password, can be implemented (step 410). Other types of log-in procedures can be used in accordance with the capabilities of the access device and the security needs of the system. If the login procedure is unsuccessful (step 412), the caller can be disconnected. (Step 414).

After a user has successfully logged in (step 412), the profile information associated with that user is retrieved (step 418) and the logged-in (or new) user is provided with a menu of options. (Step 418). Communications between the system and the user can be via text, graphics, audio, or various combinations depending on the medium(s) appropriate for the access device. For example, a user accessing the system by computer via the Internet can be provided with a sophisticated text and graphical display while a user accessing the system by a conventional telephone presented with a much simpler audio menu of options. There are multiple options which can be implemented and the option menu presented to the user (and sub-options thereof) can be customized in accordance with the user's wishes, the type of access device, and other factors. In a typical implementation, the general options which are available include registering a new switch (step 420), scheduling a new switching action (step 430), reviewing and editing an existing switching schedule (step 440),and editing the user profile (step 450).

When a user first accesses the system, they must generally register one or more switches (step 420). This can be accomplished by entering the switch ID assigned to that switch and possibly a user-friendly name identifying the appliance(s) controlled by the switch, such as “hallway lamp” or “main gate” (step 422). In addition, the user can specify a geographic location indicating where in the switch is located (step 424). If no location is specified, a default location specified by the user can be used. The registered switch information is then stored in the appropriate database. As will be appreciated, a user may register multiple switches, which switches may be located in geographically diverse locations. In a cellular-communication based implementation, the system determines a cell, base station transmitter, or other defined region within the cellular network (step 426) and registers that cell, base station, region, etc., as the home location in which that wireless device is present, and, therefore, the default location to which the cellular network will route communications for the switch (step 428). For other types of networks, different steps can be taken to determine the proper message routing or destination transmitter to be used to access a registered switch unit.

After a switch has been registered, a user can schedule a switching event (step 430). When this option is selected, the system preferably provides the user with a list of registered switches and details regarding any existing schedule, if any (step 432). The user can then select one or more of the registered switches and specify a switching action and a time when the action should occur (step 434). For example, the user may specify that all registered switches are to be turned on at 8:00 am, one switch is to be turned off at 1:00 pm and the remaining switches turned off at 10:00 pm. An error checking routine can be implemented to insure that a new schedule is consistent with prior schedules entered by the user and the selection is confirmed by the user (step 436). After the schedule is entered, and preferably approved by the user, switching events are added to the user's personal schedule table 64 and/or posted in the master event table 52 used by the event processor 34. (Step 438). (See FIG. 2). Preferably, the events listed in the Schedule 64 are linked to the hosted events in the event table 52 by a pointer, such as an event ID.

When a user requests to review or change a pending schedule (step 440), the system can retrieve the switch schedule 64 and provide it to the user (step 442). The user can then select to change or cancel any of the scheduled events. If the user chooses to change or cancel an event, that event is removed from the schedule list 64 and purged from the event table 52 and the corrected event, if any is added to the schedule and re-posted to the event table. (Steps 444, 446, 448).

In addition, the user can be permitted to update their user profile (step 450). As shown in FIG. 4, the current profile is first indicated to the user (step 452). The user can then enter profile data adjustments (step 454). If the changes are approved by the user (step 456), the profile data is updated accordingly. (step 458).

If no further changes or options are selected (step 460), the caller is disconnected (step 414). Otherwise, the user is returned to the main menu and additional selections can be made.

Various techniques can be used to manage the defined switching events. In one embodiment, the event processor is the gateway through which scheduling events are added the master event table 52. When a new switching schedule is defined by the user, the appropriate switching events are defined by the primary system 30 and passed to the event processor 34 which posts them to the event table 52 and returns the associated event ID. When the event processor receives a signal indicating that a scheduled event has occurred, the event data is retrieved and the geographic location of the affected switches is determined, perhaps with reference to the master switching table 54. Switch control messages are then generated for each of the effected switches. The messages are then forwarded to the communication network where they are routed to the appropriate transmitter for broadcast. In addition, a signal can be sent to the billing system, 36, perhaps through the switch control system 30, so that the user can be properly billed for the switching service. If the event is complete, it is removed from the master event table. If the switching event is a periodic or recurring event, the event is rescheduled or otherwise processed as required.

In addition to managing the broadcast of switch unit control messages, the present system also provides various ways in which system users can be billed for the provided switching service. Preferably, billing is performed on a per-message basis. Alternatively, users can be charged on a per-switch or bulk rate. Invoices can be generated and forwarded to users using conventional techniques. Preferably, however, when the system 12 is integrated within an existing wireless communications network, the service charges are passed to the wireless billing system and included as additional charges on the user's cellular telephone bill.

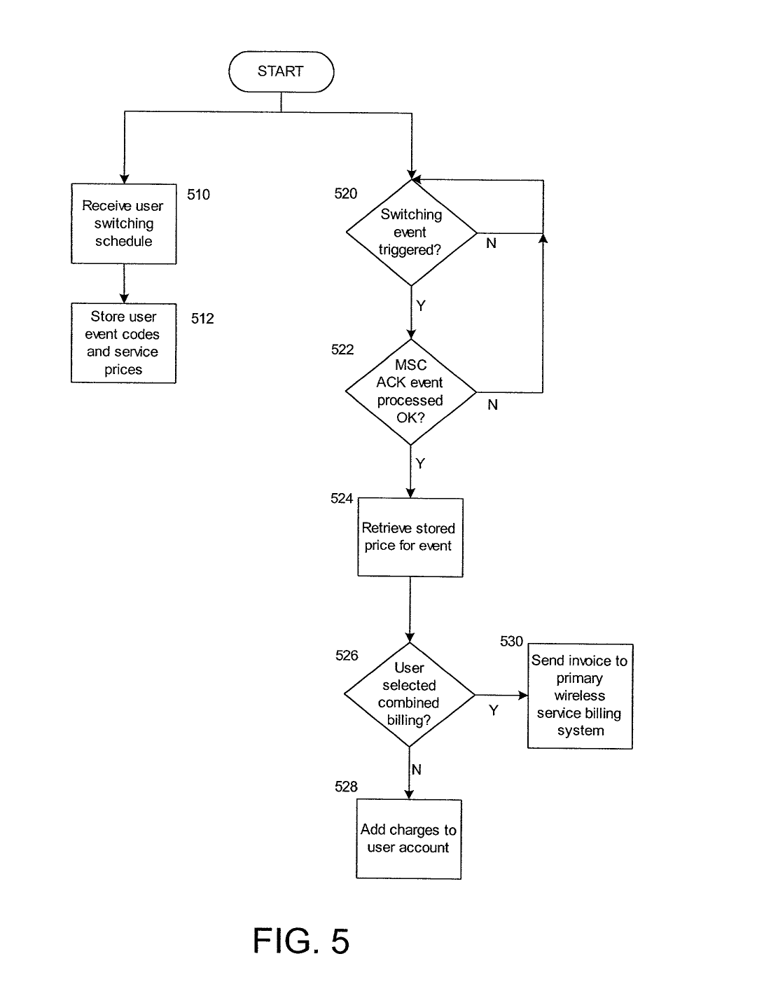

FIG. 5 is a simplified flowchart of one embodiment of such a billing system. Two general processes are involved. In the first process, when a switch is registered or a switching schedule is defined, this information is forwarded to the billing system (step 510) and event codes and determined service prices are generated and stored. (Step 512). The second process is followed when a switching event occurs. When an event is triggered (step 520), the system waits until the mobile switching system (or another network controller) indicates that the message has been successfully transmitted to the switch unit (step 522). If the switch units are configured to transmit, this check can also verify that the switch has received the message. The stored price and user data for the event is then retrieved and the charge for the event (if not pre-defined) is calculated. (Step 524). If the user has selected a combined billing (step 526), an invoice message is generated and sent to the primary wireless service billing system and the service charges will be added to the user's general bill. Otherwise, the charges are added to a separate user account (step 528) and switching service bills are subsequently generated.

While the invention has been shown and described with reference to preferred embodiments thereof, it will be understood by those skilled in the art that various changes in form and details may be made without departing from the spirit and scope of the invention.

1. A system for signaling a plurality of remotely located wireless switching devices via a wireless network, the system comprising:
a switching control system configured to receive switch registration and switch scheduling information from a plurality of users;
a database associating each registered switch with a respective user and containing the switch scheduling information;
an event processor configured to send a message to designated switches in response to switching events defined in accordance with the scheduling information.

2. The system of claim 1, further comprising an event table indicating switching events for designated switches.

3. The system of claim 1, wherein switch registration information comprises a switch ID and a geographic location of the switch.

4. The system of claim 3, wherein the wireless network comprises a plurality of transmitters for communicating with wireless devices, the switching control system being configured to select a particular transmitter for broadcasting messages to a designated switch in accordance with the specified geographic location of the designated switch.

5. The system of claim 3, wherein the wireless network comprises a cellular network having a plurality of cells, the switching control system being configured to indicate to the cellular network that a designated switch is present in a particular cell covering the specified geographic location of the designated switch.

6. The system of claim 1, further comprising a switch billing system configured to assess service charges to users in accordance with executed switching events.

7. The system of claim 6, wherein the switch billing system is further configured to forward assessed service charges to a wireless network billing system, the wireless network billing system issuing combined bills including assessed service charges and wireless network charges.

8. A method for signaling wireless switching devices via a wireless network on behalf of a plurality of users, each switching device having a switch ID, the method comprising the steps of:
receiving a plurality of switch registrations, each registration associating at least one switch ID with a particular user;
receiving switch schedule information from a user setting a switching time for a designated switch ID associated with the user;
at least approximately at each defined switching time for a given switch:
generating a switch message for the given switch; and
sending the switch message to a transmitter;
wherein the transmitter broadcasts the message via a wireless communication medium.

9. The method of claim 8, further comprising the steps of:
defining a switching event for each scheduled switching time, the switching event definition specifying the designated switch ID, the switch messages being generated upon the occurrence of defined switching events:

10. The method of claim 8, further comprising the step of, upon the occurrence of a successful transmission of a switch message, providing notice of the switching activity to a billing system.

11. The method of claim 8, wherein:
the wireless network comprises a plurality of transmitters; and
each switch ID is associated with a geographic region;
the method further comprising the step of routing the switch message to a transmitter in the geographic region associated with the switch ID in the switch message.

12. The method of claim 8, wherein:
the wireless communication medium comprises a cellular telephone network having a plurality of cells served by respective transmitters;
the switch registration associates the switch ID with a geographic region;
the method further comprising the steps of:
identifying a cell which covers the geographic region associated with a designated switch; and
indicating to the cellular network that the designated switch is present in the identified cell.

13. A method for signaling wireless switching devices on behalf of a plurality of users via a cellular network having a plurality of cells, the method comprising the steps of:
receiving switching unit information for a plurality of switching units, the information specifying for each switching unit a switch ID and a geographic region where the switching unit is located;
identifying a cell which covers the geographic region associated with a particular switching unit;
registering the particular switching unit with the cellular network as a wireless device which is present in the identified cell;
receiving switch schedule information indicating that the particular switching unit should be switched at a designated time;
at approximately the designated time:
generating a switch message including the switch ID for the particular switching unit; and
passing the switch message to the cellular network, wherein the cellular network will route the message to a base station transmitter serving the identified cell for subsequent transmission.
